(19) United States
(12) Patent Application Publication
(10) Pub. No.: US 2021/0269226 A1
(43) Pub. Date: Sep. 2, 2021

(54) Chip Container Helper

(71) Applicant: John Michael Loudon, Redding, CA (US)

(72) Inventor: John Michael Loudon, Redding, CA (US)

(21) Appl. No.: 17/189,126

(22) Filed: Mar. 1, 2021

Related U.S. Application Data
(60) Provisional application No. 62/983,654, filed on Feb. 29, 2020.
(60) Provisional application No. 63/030,169, filed on May 26, 2020.

(51) Int. Cl. B65D 83/00; B65D 81/36; B65D 85/62

(52) U.S. Cl. CPC B65D 83/005; B65D 85/62; B65D 81/36

(57) ABSTRACT

A snack dispensing insert positioned within a container, such that the snack dispensing insert holds and dispenses snack media housed within the container is presented. The snack dispensing insert contains an insert body, a handle, and a base. The handle is connected terminally opposite to the base, along the insert body. The base is connected perpendicular to the insert body. The snack dispensing insert is made out of a sheet-like material that is flexible and food-safe. This sheet-like material may take the form of biodegradable polymers, foils, papers, cardboard or any other suitable material. The snack dispensing insert allows a user to pull the snack dispensing insert out of the container, partially or entirely, such that the snack media is easily accessible by the user. Additionally, the snack dispensing insert also serves as a standalone snack tray, allowing the user to place the snack dispensing insert along a flat surface.

The current application claims a priority to the U.S. Provisional Patent application Ser. No. 62/983,654 filed on Feb. 29, 2020 and a priority to the U.S. Provisional Patent application Ser. No. 63/030,169 filed on May 26, 2020.

### FIELD OF THE INVENTION

The present invention relates generally to a snack dispensing device. More specifically, the present invention is a snack dispensing insert that dispenses snack media within a container.

### BACKGROUND OF THE INVENTION

Removal of foodstuffs from containers, particularly from the bottom of containers which are too long and narrow to accommodate the hand, has been almost a classical problem. Commonly a user will want only a few pieces of the food and dislikes emptying the whole container for those few pieces. Moreover, the problem is frequently complicated by packing the food in a liquid so that it is undesirable to reach into the container and the container cannot be over-turned to shake out the contents without spilling out the liquid. Therefore, it is an objective of the present invention to solve these problems.

The present invention is directed to an insert structure which can be packed in a container by the packer during packing. The insert is a simple and easily fabricated structure. It can be made to have sufficient strength to support foodstuffs and yet have sufficient flexibility to be useful even in slightly necked containers. It is easily manufactured and can be manufactured for a cost which will not materially increase the cost of the product to the manufacturer or to the ultimate consumer. It can be made of resilient material which is inoffensive in appearance and which is incapable of harming, discoloring or making distasteful any of the foodstuffs in the container. Moreover, it can be made transparent so that when included in a transparent container it is hardly noticeable. In addition, the insert will tend to hug the container walls so that it does not materially decrease the packing volume and so that the foodstuffs packaged will not be damaged by it in any way.

### SUMMARY OF THE INVENTION

The present invention is a snack dispensing insert positioned within a container, such that the snack dispensing insert holds and dispenses snack media housed within the container. The snack dispensing insert comprises an insert body, a handle, and a base. The handle is connected terminally opposite to the base, along the insert body. The base is connected perpendicular to the insert body. In the preferred embodiment of the present invention, the snack dispensing insert is made out of a sheet-like material that is flexible and food-safe. This sheet-like material may take the form of biodegradable polymers, foils, papers, cardboard or any other suitable material. In the preferred embodiment of the present invention, the snack dispensing insert allows a user to pull the snack dispensing insert out of the container, partially or entirely, such that the snack media is easily accessible by the user. Additionally, the snack dispensing insert also serves as a standalone snack tray, allowing the user to place the snack dispensing insert along a flat surface.

### BRIEF DESCRIPTION OF THE DRAWINGS

FIG. 1 is a diagram view of the present invention that shows the snack media being dispensed along a container through a plurality of mounting elements.

FIG. 2 is a diagram view of the present invention that shows the snack media being stored along the container.

FIG. 3 is a diagram view of the present invention that shows the snack media being taken out of the container.

FIG. 4 is a diagram view of the present invention.

FIG. 5 is a diagram view of the present invention, in accordance to another embodiment.

FIG. 6 is a diagram view of the present invention, in accordance to another embodiment that shows a rectilinear base.

FIG. 7 is a diagram view of the present invention, in accordance to another embodiment that shows a circular base.

FIG. 8 is a diagram view of the present invention, in accordance to another embodiment that shows a plurality of bases.

FIG. 9 is a diagram view of the present invention, in accordance to another embodiment that shows a pull tab.

FIG. 10 is a diagram view of the present invention, in accordance to another embodiment that shows the base positioned adjacent to a second longitudinal end.

FIG. 11 is a diagram view of the present invention that shows the snack media being dispensed along a container.

FIG. 12 is a diagram view of the present invention without the plurality of mounting elements.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

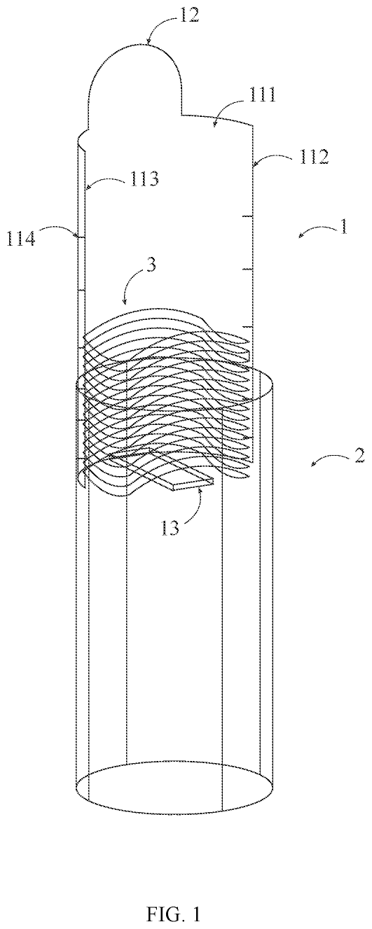

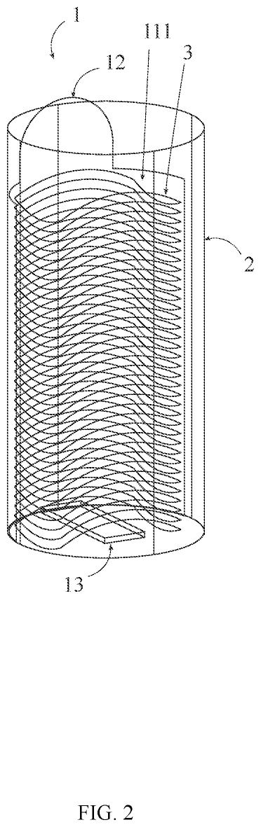

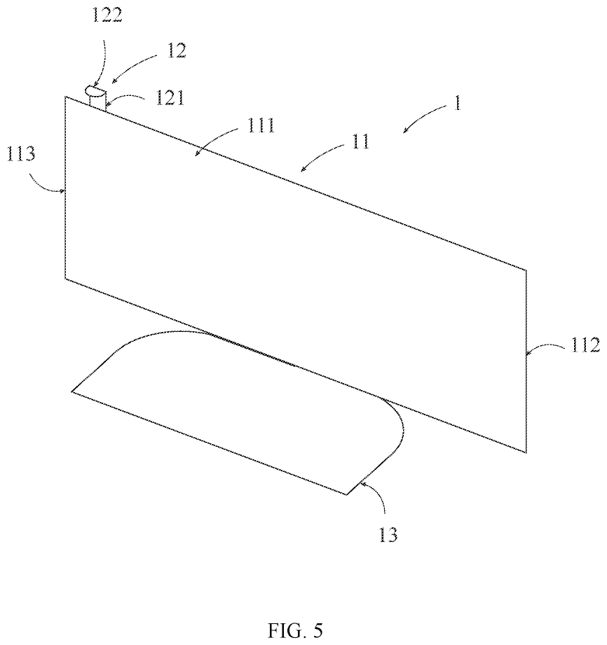

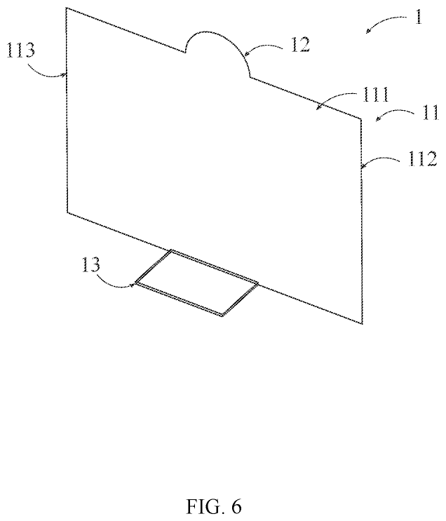

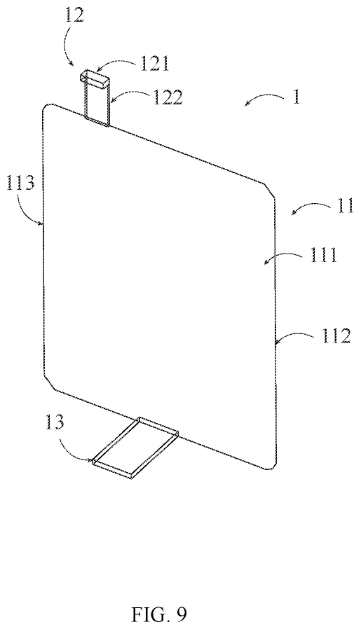

The present invention is a snack dispensing insert 1 positioned within a container 2, such that the snack dispensing insert 1 holds and dispenses snack media 3 housed within the container 2, as shown in FIGS. 1-3. The snack dispensing insert 1 comprises an insert body 11, a handle 12, and a base 13, as shown in FIGS. 1-12. The handle 12 is connected terminally opposite to the base 13, along the insert body 11. The base 13 is connected perpendicular to the insert body 11. In the preferred embodiment of the present invention, the snack dispensing insert 1 is made out of a sheet-like material that is flexible and food-safe. This sheet-like material may take the form of biodegradable polymers, foils, papers, cardboard or any other suitable material. In the preferred embodiment of the present invention, the snack dispensing insert 1 allows a user to pull the snack dispensing insert 1 out of the container 2, partially or entirely, such that the snack media 3 is easily accessible by the user. Additionally, the snack dispensing insert 1 also serves as a standalone snack tray, allowing the user to place the snack dispensing insert 1 along a flat surface.

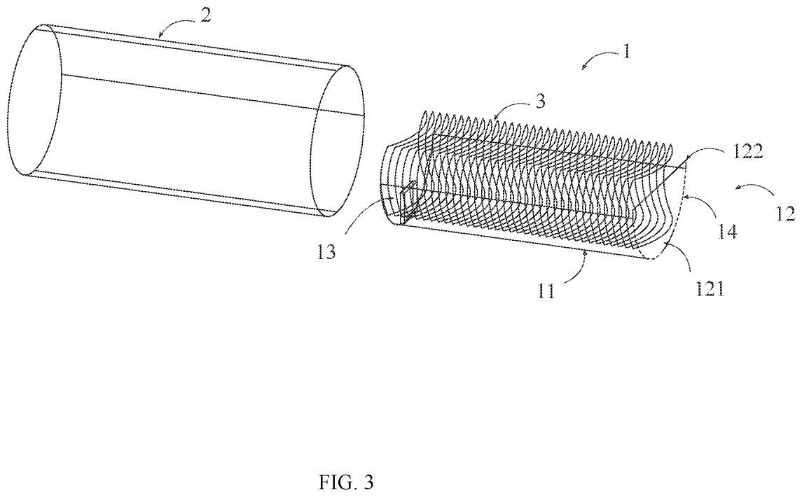

The insert body 11 comprises a storage portion 111, as shown in FIGS. 1 and 4-10. The storage portion 111 traverses from the handle 12 to the base 13 along the insert body 11. In the preferred embodiment of the present invention, the storage portion 111 is the region that holds the snack media 3 along the insert body 11. The handle 12 comprises a tab body 121 and a pull tab 122, as shown in FIGS. 3, 5, 7, and 9. The tab body 121 is connected adjacent to the insert body 11, opposite to the base 13. The pull tab 122 is connected adjacent to the tab body 121, opposite to the insert body 11. The pull tab 122 is connected perpendicular to the tab body 121. In the preferred embodiment of the present invention, the pull tab 122 is removably attached to the insert body 11 through a connection element 14, as shown in FIG. 3, where the connection element 14 secures the pull tab 122 and the insert body 11 in the shape of the container 2. In the preferred embodiment of the present invention, the connection element 14 is a perforation fastener. In various embodiments, the connection element 14 may take the form of any other suitable fastener, such as, but not limited to adhesives, tape, tear-away strips, or any other suitable fastener.

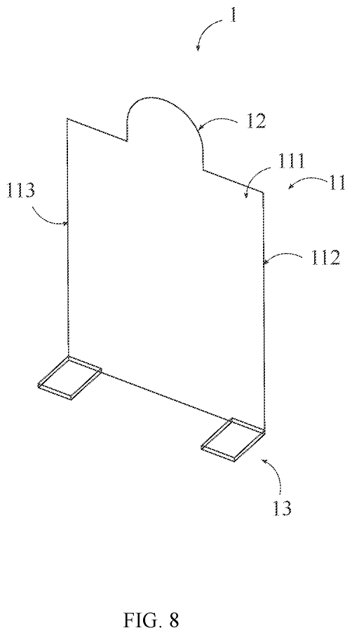

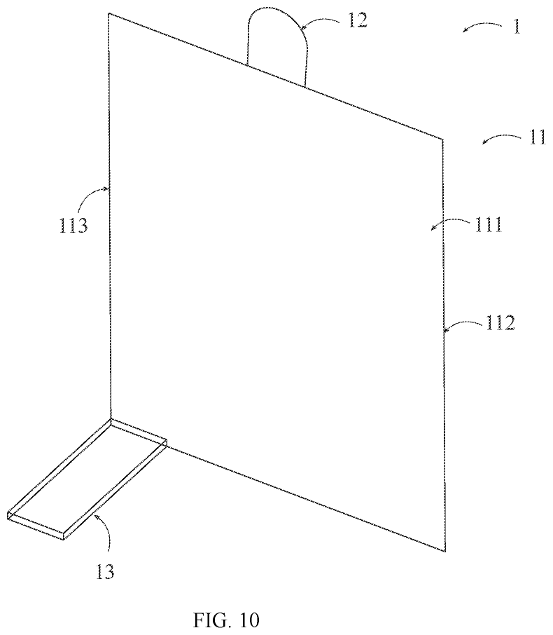

The insert body 11 comprises a first longitudinal end 112 and a second longitudinal end 113, as shown in FIGS. 1 and 4-10. The first longitudinal end 112 and the second longitudinal end 113 are positioned terminally opposite to each other along the insert body 11. The first longitudinal end 112 and the second longitudinal end 113 are positioned perpendicular to the base 13 and the handle 12. In one embodiment, the base 13 is positioned between the first longitudinal end 112 and the second longitudinal end 113, as shown in FIG. 8. In another embodiment, the base 13 is positioned adjacent to the first longitudinal end 112. In another embodiment, the base 13 is positioned adjacent to the second longitudinal end 113, as shown in FIG. 10

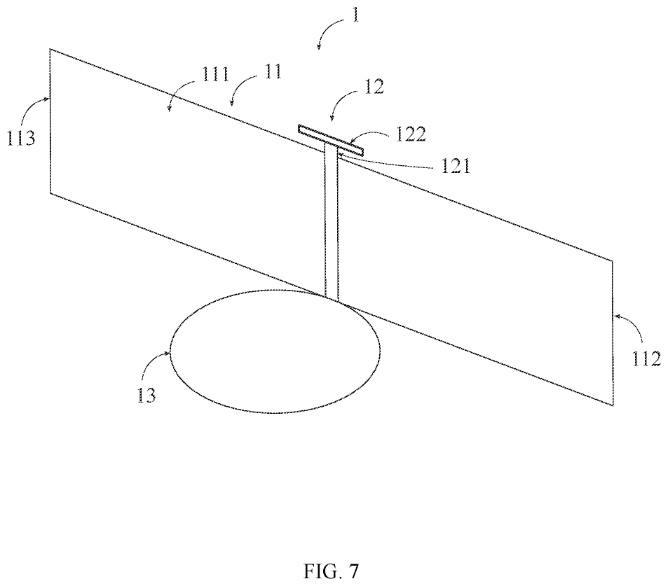

In the preferred embodiment of the present invention, the handle 12 is semi-circular in shape, as shown in FIGS. 1-2, 8, and 10. In various embodiments, the handle 12 may take the form of any suitable shape. In the preferred embodiment of the present invention, the insert body 11 is rectilinear in shape, as shown in FIGS. 1-10. In various embodiments, the insert body 11 may take the form of any suitable shape. In the preferred embodiment of the present invention, the base 13 is rectilinear in shape, as shown in FIGS. 1-4, 6, and 8-10. In another embodiment, the base 13 is circular in shape, as shown in FIG. 7. In various embodiments, the base 13 may take the form of any suitable shape.

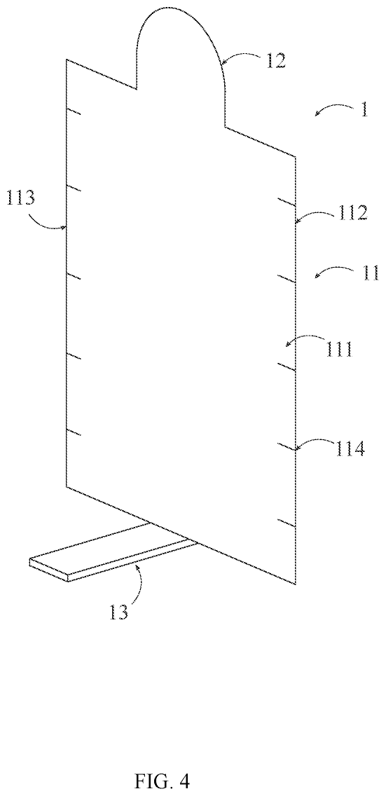

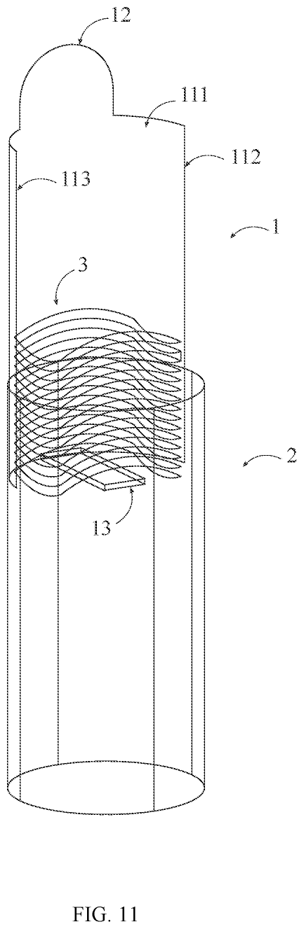

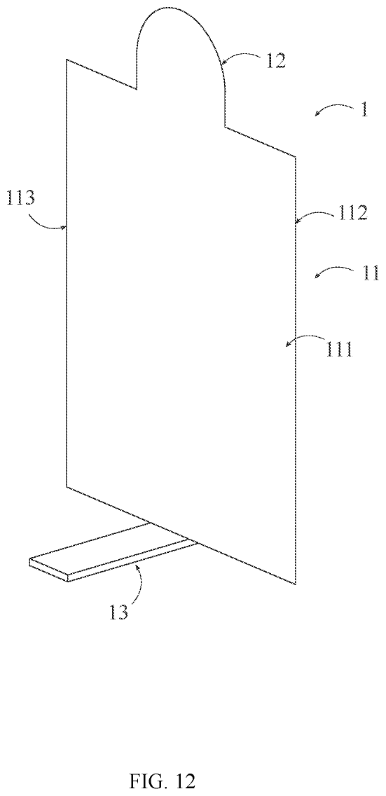

In the preferred embodiment of the present invention, the insert body 11 further comprises a plurality of mounting elements 114, as shown in FIGS. 1 and 4. The plurality of mounting elements 114 is distributed about the insert body 11. More specifically, the plurality of slits 114 is distributed about the first longitudinal end 112 and the second longitudinal end 113, where the plurality of mounting elements 114 is configured to mount the insert body 11 of the snack dispensing insert 1 on the container 2 such that the snack dispensing insert 1 is elevated along the container 2. This allows the user to prop up the snack dispensing insert 1 and expose a set amount snack media 3 out of the container 2. In the preferred embodiment of the present invention, the plurality of mounting elements 114 may take the form of pre-cut slits of constant length and spacing along the insert body 11, as shown in FIGS. 1 and 4. In various embodiments, the plurality of mounting elements 114 may take the form of any other suitable mounting implement, such as, but not limited to tabs, slots, or any other suitable mounting implement. In another embodiment of the present invention, the plurality of mounting elements 114 is not included, as shown in FIGS. 11-12. This allows the snack dispensing insert 1 to freely slide along the container 2.

Although the invention has been explained in relation to its preferred embodiment, it is to be understood that many other possible modifications and variations can be made without departing from the spirit and scope of the invention as hereinafter claimed.

What is claimed is:

1. A snack dispensing insert comprising:
an insert body;
a handle;
a base;
the handle being connected terminally opposite to the base, along the insert body; and
the base being connected perpendicular to the insert body.

2. The snack dispensing insert, as claimed in claim 1, comprising:
the insert body comprising a storage portion; and
the storage portion traversing from the handle to the base along the insert body.

3. The snack dispensing insert, as claimed in claim 1, comprising:
the handle comprising a tab body and a pull tab;
the tab body being connected adjacent to the insert body, opposite to the base; and
the pull tab being connected adjacent to the tab body, opposite to the insert body.

4. The snack dispensing insert, as claimed in claim 3, comprising:
the pull tab being removably attached to the insert body through a connection element.

5. The snack dispensing insert, as claimed in claim 4, wherein the connection element is a perforation fastener.

6. The snack dispensing insert, as claimed in claim 1, comprising:
the handle comprising a tab body and a pull tab;
the tab body being connected adjacent to the insert body, opposite to the base; and
the pull tab being connected adjacent to the tab body, opposite to the insert body; and
the pull tab being connected perpendicular to the tab body.

7. The snack dispensing insert, as claimed in claim 1, comprising:
the insert body comprising a first longitudinal end and a second longitudinal end;
the first longitudinal end and the second longitudinal end being positioned terminally opposite to each other along the insert body;
the first longitudinal end and the second longitudinal end being positioned perpendicular to the base and the handle; and
the base being positioned between the first longitudinal end and the second longitudinal end.

8. The snack dispensing insert, as claimed in claim 1, comprising:
the insert body comprising a first longitudinal end and a second longitudinal end;
the first longitudinal end and the second longitudinal end being positioned terminally opposite to each other along the insert body;
the first longitudinal end and the second longitudinal end being positioned perpendicular to the base and the handle; and
the base being positioned adjacent to the first longitudinal end.

9. The snack dispensing insert, as claimed in claim 1, comprising:
the insert body comprising a first longitudinal end and a second longitudinal end;
the first longitudinal end and the second longitudinal end being positioned terminally opposite to each other along the insert body;
the first longitudinal end and the second longitudinal end being positioned perpendicular to the base and the handle; and
the base being positioned adjacent to the second longitudinal end.

10. The snack dispensing insert, as claimed in claim 1, wherein the handle is semi-circular in shape.

11. The snack dispensing insert, as claimed in claim 1, wherein the insert body is rectilinear in shape.

12. The snack dispensing insert, as claimed in claim 1, wherein the base is rectilinear in shape.

13. The snack dispensing insert, as claimed in claim 1, wherein the base is circular in shape.

14. The snack dispensing insert, as claimed in claim 1, wherein the snack dispensing insert is made out of a sheet-like material.

15. The snack dispensing insert, as claimed in claim 1, comprising:
the insert body comprising a plurality of mounting elements; and
the plurality of mounting elements being distributed about the insert body.

16. The snack dispensing insert, as claimed in claim 1, comprising:
the insert body comprising a first longitudinal end and a second longitudinal end;
the first longitudinal end and the second longitudinal end being positioned terminally opposite to each other along the insert body;
the first longitudinal end and the second longitudinal end being positioned perpendicular to the base and the handle;
the insert body comprising a plurality of mounting elements; and
the plurality of mounting elements being distributed about the first longitudinal end and the second longitudinal end, wherein the plurality of slits is configured to mount the insert body of the snack dispensing insert on the container such that the snack dispensing insert is elevated along the container.
